(19) United States
(12) Patent Application Publication
(10) Pub. No.: US 2002/0121791 A1
(43) Pub. Date: Sep. 5, 2002

(54) Load-bearing traverse

(75) Inventors: Juergen Schulte, Krefeld (DE); Detlef Albin, Moers (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Stockhausen GmbH & Co. KG, Krefeld (DE)

(21) Appl. No.: 10/085,733

(22) Filed: Mar. 1, 2002

(30) Foreign Application Priority Data
Mar. 1, 2001 (DE) 101 10 025.6

(51) Int. Cl. B66C 1/12

(52) U.S. Cl. 294/81.5

(57) ABSTRACT

The present invention relates to a load-bearing traverse, especially for conveying big bags. The present invention also relates to a method of conveying big bags.

The present invention relates to a load-bearing traverse, especially for conveying big bags. The present invention also relates to a method of conveying big bags.

Load-bearing traverses have been known in the state of the art for many years. However, they are disadvantageous in that their overall height is relatively large, and that a relatively large spacing is present between the big bags and the load-bearing traverse.

The object of the present invention therefore is to provide a load-bearing traverse that would not involve the drawbacks of the prior art.

Said object is accomplished by means of a load-bearing traverse, especially for conveying big bags having straps, including:

a flat basic body having a top side and an underside,

at least one means for removably fastening the load-bearing traverse to a lifting gear arranged on the top side thereof, and

at least one means for removably fastening the fastening means of the item to be conveyed, preferably the straps of a big bag, to said load-bearing traverse, which means are likewise arranged on the top side thereof.

Preferably, the fastening means of the item to be conveyed is a strap of a big bag.

According to the invention, the flat basic body has a fixing point for removably fastening the load-bearing traverse to a lifting gear, e.g. a crane, and a means for removably fastening the fastening means of the item to be conveyed. According to the invention, both of these means are attached to the top side of the flat basic body. The load-bearing traverse preferably has at least four removable means to fasten the fastening means of the item to be conveyed. Preferably, these means are shackles or hooks, each of which preferably has one strap of the big bag fastened thereto.

In a preferred embodiment of the present invention, the flat basic body in its outer edge region has means for deflecting the fastening means of the item to be conveyed. Said means preferably are arranged in the region of the means for removably fastening the fastening means of the item to be conveyed. Advantageously, the deflecting means are curvatures each having a radius of from 10 to 40 mm, preferably from 15 to 20 mm. Owing to said deflecting means, the fastening means of the item to be conveyed are deflected by about 90°, thereby minimizing the stressing thereof.

It is also preferred to dimension the spacing between the means for removably fastening the fastening means of the item to be conveyed and the outer edge in a way so as to approximately correspond to the length of the fastening means of the item to be conveyed, so that these fastening means are slightly pre-tensioned upon securing. At least, the spacing should be dimensioned in a way so as to minimize the play of the fastening means subsequent to fastening to the traverse.

In another preferred embodiment, a plurality of means for removably fastening the fastening means of the item to be conveyed are provided at one position, so that the fastening means of the item to be conveyed can be fastened to the load-bearing traverse with varying length, while minimizing the play thereof.

Those skilled in the art will appreciate that the means for removably fastening the fastening means of the item to be conveyed can be arranged movably on a bar, so as to allow adjustment of the spacing between the outer edge and the means for removably fastening the fastening means of the item to be conveyed.

In a preferred embodiment of the present invention, the flat basic body is a plate. In another preferred embodiment, the flat basic body is a cross or a polygon preferably made of section steel, e.g. of an I- or H-beam.

The load-bearing traverse according to the invention is advantageous in that its overall height is relatively small, and that the spacing between a big bag and the load-bearing traverse is very small, even subsequent to lifting. The load-bearing traverse according to the invention can be produced at low cost.

The present invention is also directed to a method of conveying goods using the load-bearing traverse according to the invention, wherein the fastening means of the item to be conveyed are fastened to the means for removably fastening the straps, and the item then is lifted and conveyed, the fastening means of the item to be conveyed being slightly pre-tensioned or at least having very small play even prior to lifting.

The goods to be conveyed preferably are big bags having straps as fastening means.

This method is advantageous in that the play between the load-bearing traverse and the big bag is minimized, allowing conveyance of big bags larger than heretofore, without increasing the spacing between the crane hook and the underside of the big bag.

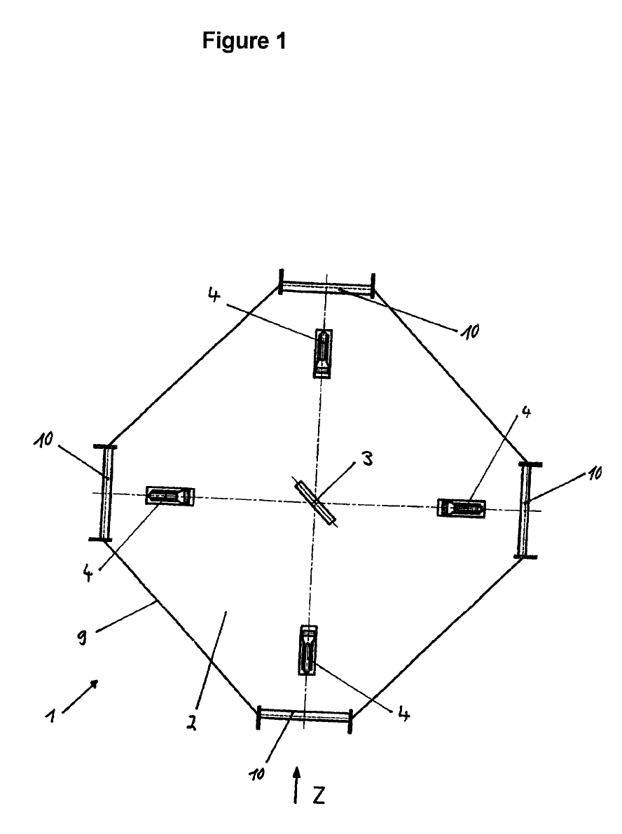

The invention will now be illustrated with reference to FIGS. 1 to 3. These illustrations are merely by way of example and do not limit the general idea of the invention.

FIG. 1 shows a top view of the load-bearing traverse according to the invention.

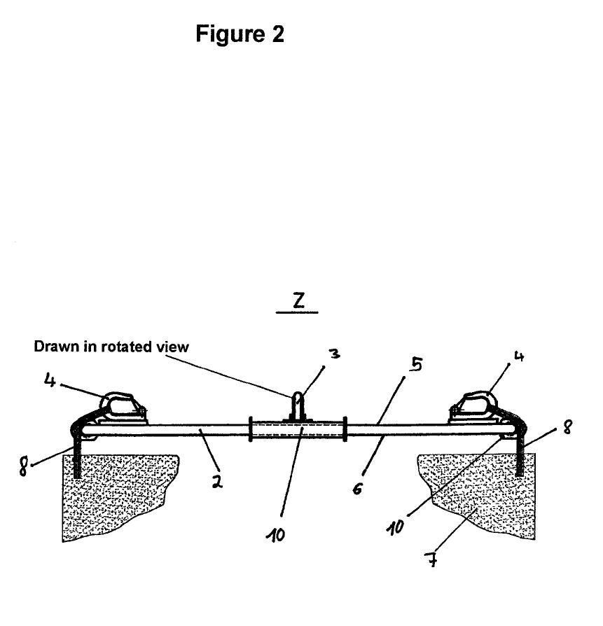

FIG. 2 shows the load-bearing traverse having a big bag secured thereto.

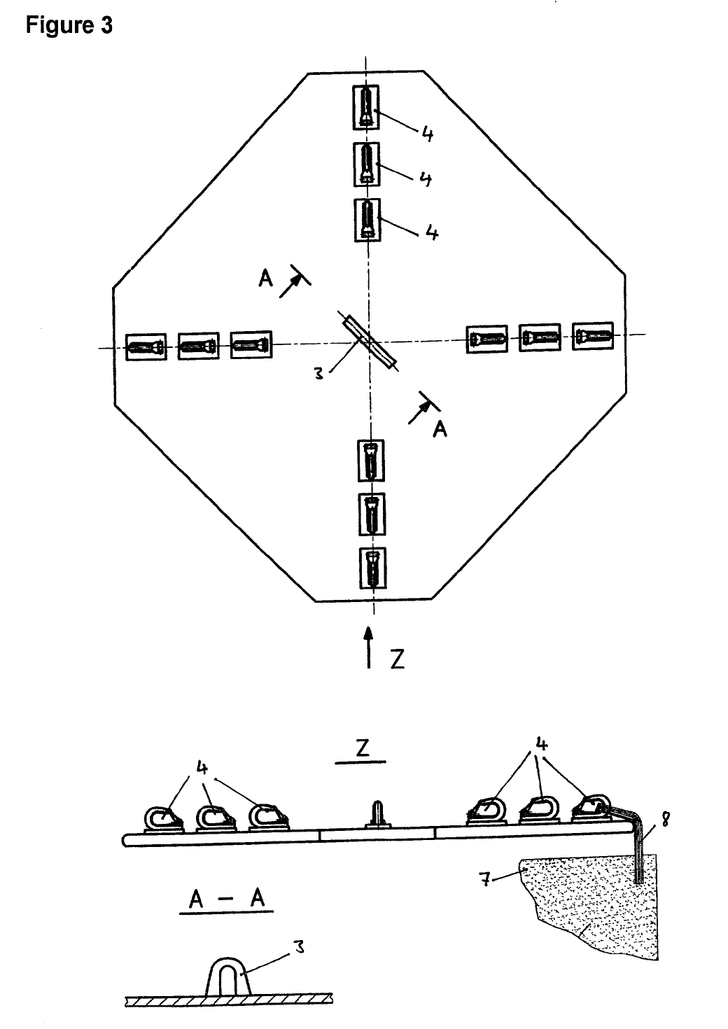

FIG. 3 shows a load-bearing traverse with a plurality of hooks arranged in line.

FIG. 1 represents a top view of the load-bearing traverse 1 according to the invention. The load-bearing traverse consists of a plate 2 having a top side 5 and an underside 6. A fixing point 3 is arranged on the top side 5 of plate 2, allowing a lifting gear to be fastened thereto. In addition, the top side has four hooks 4 arranged thereon, which can be secured in the straps of the big bag. Deflecting means 10 are situated at the outside 9 in the region of hook 4. The distance of hook 4 from the outer edge is dimensioned such that the play of the straps of the big bag is minimized.

FIG. 2 illustrates a side view of the load-bearing traverse according to the invention with a big bag 7 fastened thereto. The straps 8 of big bag 7 are secured in the hooks 4 of the load-bearing traverse. Those skilled in the art will recognize that, on the one hand, the load-bearing traverse has an exceedingly low overall height and, on the other hand, that the spacing between the basic body of the load-bearing traverse and the top side of the big bags has been minimized.

FIG. 3 shows a load-bearing traverse 1 of the invention having a plurality of hooks 4 arranged in line, allowing to secure a load-bearing traverse for big bags having straps 8 of varying length.

1. A load-bearing traverse (1), especially for conveying big bags (7) having straps (8), including:
a flat basic body (2) having a top side (5) and an underside (6),
at least one means (3) for removably fastening the load-bearing traverse to a lifting gear arranged on the top side (5) thereof, and
at least one means (4) for removably fastening the fastening means (8) of the item (7) to be conveyed, preferably straps (8) of a big bag (7), to said load-bearing traverse, which means (4) are likewise arranged on the top side (5) thereof.

2. The load-bearing traverse according to claim 1, characterized in that the load-bearing traverse has at least 2, preferably 3 or 4 means (4) for removably fastening the fastening means (8).

3. The load-bearing traverse according to claim 1 or 2, characterized in that the flat basic body (2) in its outer edge (9) region has means (10) for deflecting the fastening means (8).

4. The load-bearing traverse according to any of claims 1 to 3, characterized in that the distance of means (4) from the outer edge (9) approximately corresponds to the length of fastening means (8).

5. The load-bearing traverse according to any of claims 1 to 3, characterized in that a plurality of means (4) are arranged in line, allowing to secure fastening means (8) of varying length.

6. The load-bearing traverse according to one or more of the preceding claims, characterized in that the flat basic body (2) is a plate.

7. The load-bearing traverse according to one or more of the preceding claims, characterized in that the flat basic body (2) is a cross or a polygon, preferably made of section steel.

8. A method of conveying goods using the load-bearing traverse according to any of claims 1 to 7, characterized in that the fastening means (8) of the item (7) to be conveyed are fastened to means (4), and the item (7) is lifted and conveyed, the fastening means (8) being slightly pre-tensioned or at least having very small play even prior to lifting.

9. The method according to claim 8, characterized in that the item a big bag.
